(19) United States
(12) Patent Application Publication
(10) Pub. No.: US 2026/0095250 A1
(43) Pub. Date: Apr. 2, 2026

(54) ALIGNMENT CORRECTION AND SEARCH IN FREE SPACE OPTICAL COMMUNICATIONS TERMINALS

(71) Applicant: TAARA CONNECT, INC., Sunnyvale, CA (US)

(72) Inventors: Aleksandra Kalinowska, San Francisco, CA (US); Paul Csonka, Sunnyvale, CA (US); Caio Christovao da Silva Porto, San Jose, CA (US); Andrei Kazmierski, Pleasanton, CA (US)

(21) Appl. No.: 19/290,613

(22) Filed: Aug. 5, 2025

Related U.S. Application Data
(60) Provisional application No. 63/700,800, filed on Sep. 30, 2024.

(51) Int. Cl. H04B 10/03; H04B 10/11

(52) U.S. Cl. CPC H04B 10/03; H04B 10/11

(57) ABSTRACT

Aspects of the disclosure provide systems and methods for real-time alignment correction and searching to reestablish lost communications links in terrestrial FSOC systems. In some instances, a communication link with a second optical communication terminal may be determined to be lost. In response, a set of search positions may be determined. A first of the search positions may be based on a directional alignment error associated with a difference between a reference elevation angle measured before the communication link was lost and a second elevation angle measured after the communication link was lost. A second of the search positions may be based on a directional alignment error associated with a reference image captured before the communication link was lost and a second image captured after the communication link was lost. A search may be conducted based on the set of search positions in order to reestablish the communication link.

### CROSS REFERENCE TO RELATED APPLICATIONS

The present application claims the benefit of the filing date of U.S. Provisional Application No. 63/700,800, filed Sep. 30, 2024, the entire disclosure of which is incorporated by reference herein.

### BACKGROUND

Wireless optical communication enables high-throughput and long-range. Communication terminals may transmit and receive optical signals through free space optical communication (FSOC) links. In order to accomplish this, such terminals generally use acquisition and tracking systems to establish and maintain the optical link by pointing optical beams towards one another. For instance, a transmitting terminal may use a beacon laser or the optical beam itself to illuminate a receiving terminal, while the receiving terminal may use a position sensor to locate the transmitting terminal and to monitor the beacon laser or optical beam. Steering mechanisms may maneuver the terminals to point toward each other and to track the pointing once acquisition is established. A high degree of pointing accuracy may be required to ensure that the optical signal will be correctly received.

### BRIEF SUMMARY

Aspects of the disclosure provide a system including a first optical communication terminal. The first optical communication terminal has one or more processors configured to determine that a communication link with a second optical communication terminal has been lost; in response to determining that the communication link has been lost, identify a set of search positions for conducting a search, wherein a first of the search positions is based on a directional alignment error associated with a difference between a reference elevation angle measured before the communication link was lost and a second elevation angle measured after the communication link was lost, and wherein a second of the search positions is based on a directional alignment error associated with a reference image captured before the communication link was lost and a second image captured after the communication link was lost; and conduct a search based on the set of search positions in order to reestablish the communication link.

In one example, the first optical communication terminal further includes a sensor, and the one or more processors are further configured to use the sensor to measure the reference elevation angle and the second elevation angle. In this example, the sensor includes one of an inertial measurement unit, a gyroscope, or an accelerometer. In another example, the first optical communication terminal further includes a camera, and the one or more processors are further configured to capture the reference image and the second image. In another example, the one or more processors are further configured to select the reference image based on when the second image was captured. In another example, the one or more processors are further configured to determine the directional alignment error associated with the reference image using image registration between the reference image and the second image. In another example, the one or more processors are further configured to use a light source of the second optical communication terminal in each of the reference image and the second image to determine the directional alignment error associated with the reference image. In another example, the set of search positions further includes a historical position of a steering mirror of the first optical communication terminal. In another example, the one or more processors are further configured to conduct the search by determining an average of the search positions of the set and adjusting the first optical communication terminal based on the average before initiating the search. In another example, the one or more processors are further configured to conduct the search by selecting one of the set of search positions and adjusting the first optical communication terminal based on the selected one before initiating the search. In another example, selecting the selected one is further based on error values associated with each of the directional alignment errors. In another example, the one or more processors are further configured to conduct the search by determining a trajectory for the search using a probability distribution for the set of search positions, and wherein the search is conducted based on the trajectory. In this example, the one or more processors are further configured to determine the trajectory using an ergodic approach.

A further aspect of the disclosure provides a method. The method includes determining, by one or more processors of a first optical communication terminal, that a communication link with a second optical communication terminal has been lost; in response to determining that the communication link has been lost, identifying, by the one or more processors, a set of search positions for conducting a search, wherein a first of the search positions is based on a directional alignment error associated with a difference between a reference elevation angle measured before the communication link was lost and a second elevation angle measured after the communication link was lost, and wherein a second of the search positions is based on a directional alignment error associated with a reference image captured before the communication link was lost and a second image captured after the communication link was lost; and conducting, by the one or more processors, a search based on the set of search positions in order to reestablish the communication link.

In one example, the method also includes using a sensor of the first optical communication terminal to measure the reference elevation angle and the second elevation angle. In another example, the directional alignment error associated with the reference image is determined using image registration between the reference image and the second image. In another example, the direction al alignment error is determined using a light source of the second optical communication terminal captured in each of the reference image and the second image to. In another example, conducting the search includes determining an average of the search positions of the set and adjusting the first optical communication terminal based on the average before initiating the search. In another example, conducting the search includes determining a trajectory for the search using a probability distribution for the set of search positions, and wherein the search is conducted based on the trajectory. In this example, determining the trajectory includes using an ergodic approach.

### BRIEF DESCRIPTION OF THE DRAWINGS

FIG. 1 is a block diagram of a first optical communication terminal and a second optical communication terminal in accordance with aspects of the disclosure.

FIG. 2 is a pictorial diagram of an example system architecture for the first optical communications terminal of FIG. 1 in accordance with aspects of the disclosure.

FIG. 3 is a pictorial diagram of a network in accordance with aspects of the disclosure.

FIG. 4 is an example of a first optical communication terminal aligned with a second optical communication terminal such that a communication link is established between the communication terminals in accordance with aspects of the disclosure.

FIG. 5 is an example of a first optical communication terminal that is out of alignment with a second optical communication terminal such that a communication link is lost between the communication terminals in accordance with aspects of the disclosure.

FIG. 6 is an example reference image in accordance with aspects of the disclosure.

FIG. 7 is an example image in accordance with aspects of the disclosure.

FIG. 8 is an example representation of an image registration process between two images in accordance with aspects of the disclosure.

FIG. 9 is an example of an image offset and image offset vector in accordance with aspects of the disclosure.

FIG. 10 is an example of a search pattern in accordance with aspects of the disclosure.

FIG. 11 is an example of a search pattern in accordance with aspects of the disclosure.

FIG. 12 is a flow diagram in accordance with aspects of the disclosure.

### DETAILED DESCRIPTION

### Overview

The technology relates to alignment correction and searching to establish or reestablish lost communications links in terrestrial free space optical communications (FSOC) systems. In such systems, two remotely located communication terminals may have to point at each other with relatively high precision (e.g., within a few inches or a few microradians) at distances of 1-20 km in order to send and receive beams of light from one terminal to the other. Even in situations where such devices are fixed to a mounting structure, terrestrial terminals, due to environmental conditions (e.g., vibrations, weather conditions, etc.), may fall out of alignment or become misaligned. In such instances, the communication terminals may simply wait for a human operator to correct the alignment or conduct a “blind” search in its field of regard (FOR) or the area that the communication terminal can perceive via its telescope. As an example, a raster scan may be conducted to reacquire a link (establish proper pointing). Typical search processes for correcting alignment may be time consuming and somewhat inefficient as a communication terminal's telescope may have a reasonably large FOR while the actual beam of light will have a much narrower width. To improve these inefficiencies, search positions determined from directional alignment errors based on on-board sensors and/or historical alignment data may be used to conduct a more efficient search in order to realign the devices.

As an example, a system may include a plurality of communication terminals. A pair of these communication terminals may have telescopes with apertures for transmitting and receiving light that are oriented towards one another at installation in order to establish a communication link between the communication terminals. At some point in time, the communication terminals may come out of alignment. This may terminate all communications between the terminals. In other words, the communication terminals may no longer receive the beams of light from one another. In response, one or both of the communication terminals may identify one or more search positions.

These search positions may be determined in any number of ways. For example, a search position may be determined using a directional alignment error. In one example, location and elevation information from two different locations and differences in local tip/tilt data may be used to find a directional alignment error. In this regard, a current pointing vector for a communication terminal may be used to find a directional alignment error from the current pointing vector of the communication terminal.

In addition or alternatively, a directional alignment error may be determined using image registration. For instance, after a link is established, a camera may be used to capture an initial reference image of the remote environment. This “reference” image may then be stored locally at the communication terminal. This reference image may be updated periodically or rather a new image may be captured and stored. The period may also be adjusted as conditions change. When the communication link is lost, the communication terminal may capture a new image of the environment and compare it with the last stored reference image when the communication link was active. For instance, image registration or machine learning may be used to determine an image offset vector representative of a physical difference between features in the images. This image offset vector may therefore be a directional alignment error.

In addition or alternatively, tracking positions may be periodically recorded. A tracking position may represent an angular orientation of a beam of light of a communications terminal during any point in time when the terminal is able to receive power from a beam of light emitted from another communications terminal. A tracking position may be calculated using any combination of the angular position of the steering mirror, orientation of the terminal, orientation of the telescope, and/or incidence angle of the beam measured via an optical phased array (OPA) or other features. For instance, during tracking, the angular orientation of a steering mirror may be adjusted in order to reorient the beam of light in real time in order to make adjustments due to small environmental changes that may affect the power of the beam of light received at the other communication terminal. In this regard, this tracking allows the communication link between the communication terminals to be maintained. Each time the steering mirror is adjusted, the new position of the steering mirror (e.g., new tracking position) may be stored as historical alignment data. In addition or alternatively, tracking positions at different times of day for different days, weeks, months, seasons, etc., may be stored as historical alignment data for later retrieval as search positions for corresponding times of day, etc.

The one or more directional alignment errors or historical alignment data may be used to correct the alignment between the two communication terminals. In one example, the one or more directional alignment errors or historical alignment data may be sent to a remote computing device and provided to a human operator to enable the human operator to physically correct the alignment. Thereafter, a search may be conducted. For example, the communication terminal may then “step” through its field of regard in a thorough pre-defined pattern starting from the corrected position, with the goal of locating a beam of light being transmitted from another communication terminal. If a search starting at a search position based on one of the directional alignment errors or historical alignment data does not result in a connection between the two terminals, the human operator may orient the aperture of the communication terminal towards another using the one or more directional alignment errors or historical alignment data. This may continue until the search is successful and a communications link is established between the communication terminals.

Alternatively, the communication terminal may determine a search position, reorienting the beam of light, and initiate a search to correct for the misalignment automatically. For instance, the communication terminal may take an average of two or more search positions and use this location as a search position. The communication terminal may then reorient the beam of light to that search position to compensate for the directional alignment error. Thereafter, a search may be conducted. For example, as described above, the communications terminal may then “step” through its field of regard in a thorough pre-defined pattern starting from the search position, with the goal of locating the beam being transmitted from another communication terminal.

In another example, the communication terminal may determine a search position by selecting one of the one or more search positions, reorienting the beam of light, and initiating a search to correct for the misalignment automatically. If the search starting at the determined search position does not result in a connection between the two terminals, the communication terminal may determine another search position, for example, by selecting another search position, reorienting the beam of light of the communication terminal to that search position, and conducting another search. This may continue until the search is successful and a communications link is established between the communication terminals.

The selection of the one or more directional alignment errors may be based on a predefined list, starting with the search position with the least amount of expected error and working towards the search position with the greatest amount of expected error value, vice versa, or randomly.

Alternatively, the communication terminal may conduct a distributed search using a plurality of the directional alignment errors. This may enable a search of the FOR with a trajectory that prioritizes exploring angles with a high likelihood of successful alignment. This probability-based approach may therefore guide the search using the distributions of the error values and result in faster and more reliable reacquisition than either a blind search of the full field of regard or any type of raster-based search.

The features described herein provide for real-time alignment correction and searching to reestablish lost communications links in terrestrial free space optical communications (FSOC) systems. This alignment correction and search process may increase efficiency of searches, significantly reducing the time needed to establish an initial connection and reestablish a connection between communication terminals after a communications link is lost. These improvements to the acquisition and reacquisition processes may therefore significantly reduce downtime for the system. In addition, the features described herein may also improve transparency of system operations to human operators, enabling the human operators to intervene promptly when issues are not possible to be fixed autonomously.

### Example Systems

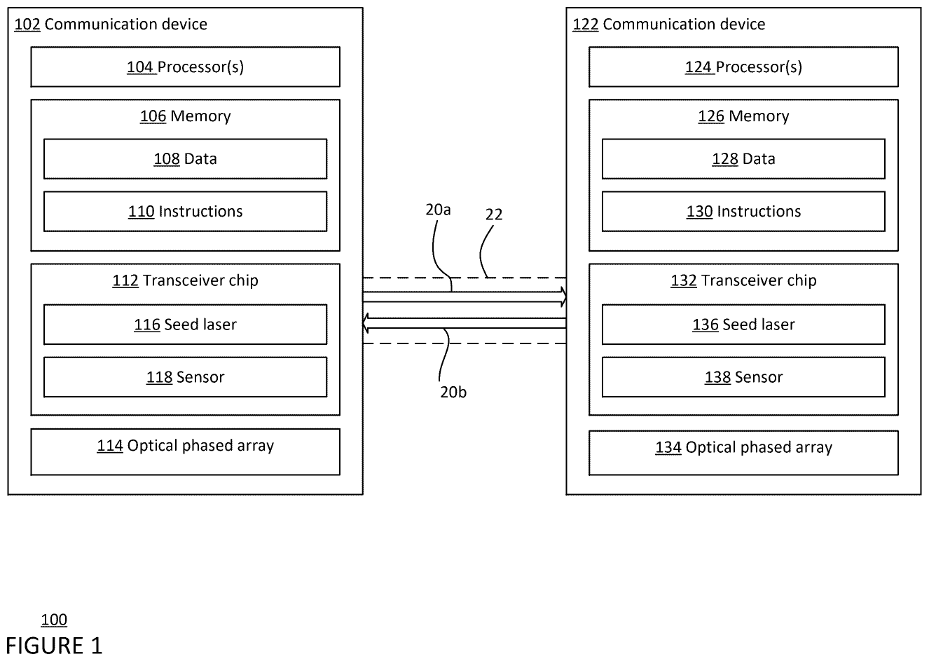

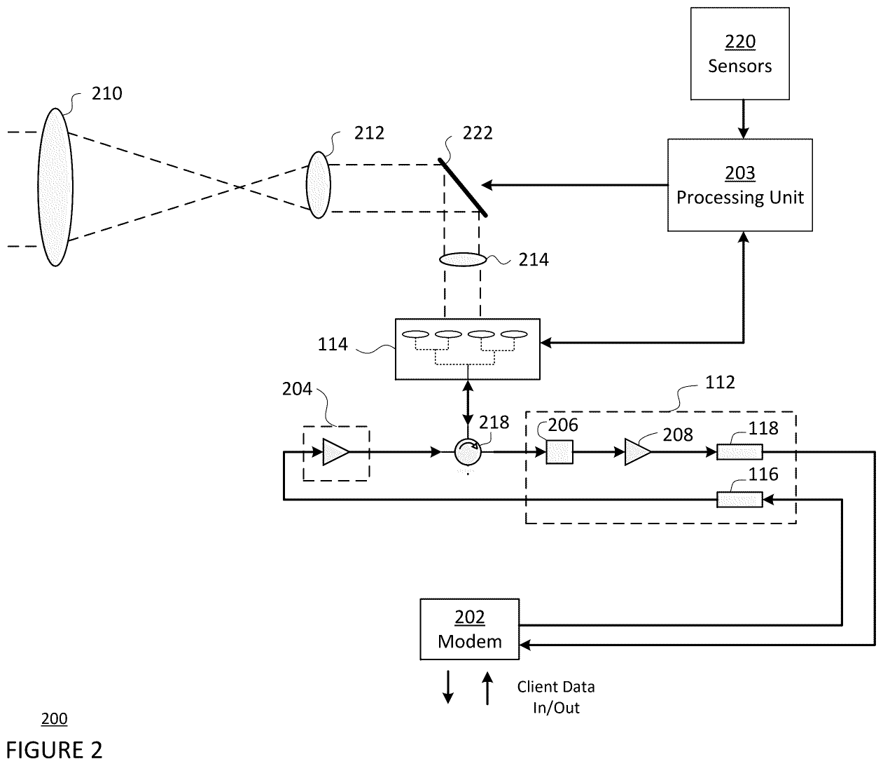

FIG. 1 is a block diagram 100 of a first optical communications terminal configured to form one or more links with a second optical communications terminal, for instance as part of a system such as a FSOC system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture may facilitate some beam steering without moving parts. The OPA architecture may include a micro-lens array, an emitter associated with each micro-lens in the array, a plurality of phase shifters, and waveguides that connect the components in the OPA. The OPA architecture may be positioned on a single chip or photonic integrated chip or (PIC). The waveguides progressively merge between a plurality of emitters and an edge coupler that connect to other transmitter and/or receiver components. In this regard, the waveguides may direct light between photodetectors or fiber outside of the OPA architecture, the phase shifters the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA architecture 114 may receive light from the transmitter components and outputs the light as a coherent communications beam to be received by a remote communications terminal, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

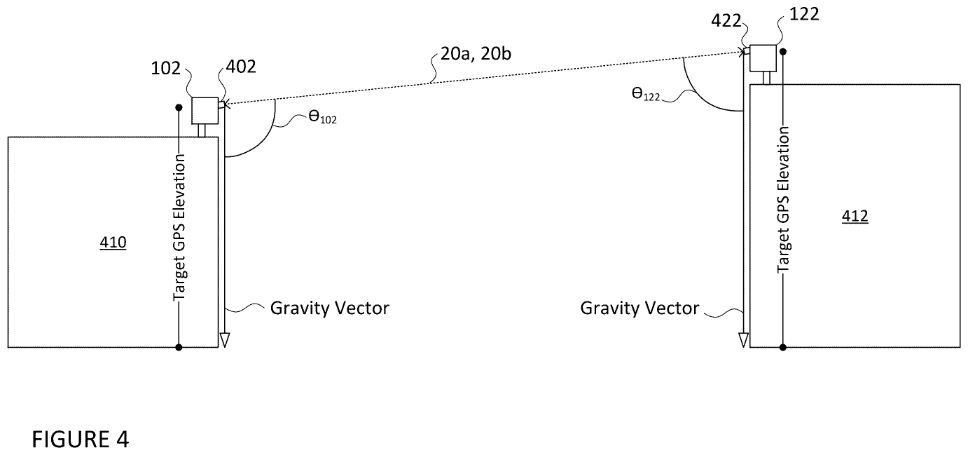

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope 402 (show in FIG. 4) including an objective lens 210, an eyepiece lens 212, a steering mirror 222, and an aperture 214 (or opening) through which light may enter and exit the communications terminal. For case of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (such as steering mirror 222. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers, or waveguides, connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam or beam of light 20b pointed towards the first optical communications terminal 102, which receives the beam of light 20b as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

Although the examples described herein relate to OPA architectures, in other instances other features may be used. For instance, an APD (avalanche photodiode) and/or a PSD (position-sensitive detector, also a photodiode) may be used instead of an OPA for detecting the light beam and its incidence angle by an optical communications terminal. In addition, or alternatively, instead of an OPA, a laser with an EDFA (erbium-doped fiber amplifier) may be used for transmitting beams of light from a communications terminal.

A communication link 22 may be formed between the first optical communications terminal 102 and the second optical communications terminal 122 when the transceivers of the first and second optical communications terminals are aligned. The alignment can be determined using the optical communications beams or beams of light 20a, 20b to determine when line-of-sight is established between the first and second optical communications terminals 102, 122. Using the communication link 22, the one or more processors 104 can send communication signals using the beam of light 20a to the second optical communications terminal 122 through free space, and the one or more processors 124 can send communication signals using the beam of light 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

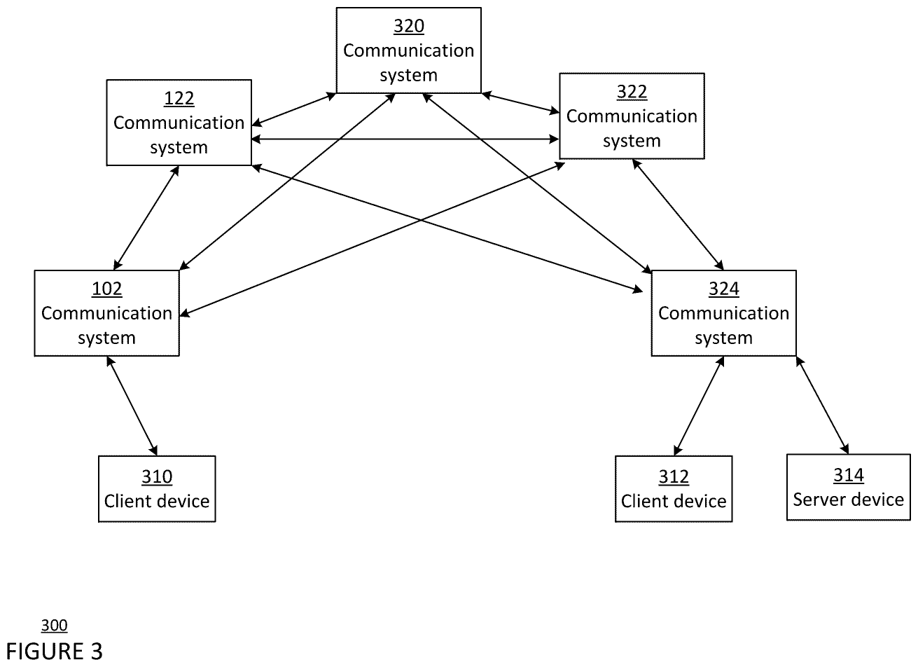

As shown in FIG. 3, a plurality of communications terminals, such as the first optical communications terminal 102 and the second optical communications terminal 122, may be configured to form a plurality of communication links (illustrated as arrows) between a plurality of communications terminals, thereby forming a network 300. The network 300 may include client devices 310 and 312, server device 314, and communications terminals 102, 122, 320, 322, and 324. Each of the client devices 310, 312, server device 314, and communications terminals 320, 322, and 324 may include one or more processors, a memory, a transceiver chip, and an OPA architecture (e.g., OPA chip or chips) similar to those described above. Using the transmitter and the receiver, each communications terminal in network 300 may form at least one communication link with another communications terminal, as shown by the arrows. The communication links may be for optical frequencies, radio frequencies, other frequencies, or a combination of different frequency bands. In FIG. 3, the first optical communications terminal 102 is shown having communication links with client device 310 and communications terminals 122, 320, and 322. The second optical communications terminal 122 is shown having communication links with communications terminals 102, 320, 322, and 324.

The network 300 as shown in FIG. 3 is illustrative only, and in some implementations the network 300 may include additional or different communications terminals. The network 300 may be a terrestrial network where the plurality of communications terminals is on a plurality of ground communications terminals. In other implementations, the network 300 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 300 may serve as an access network for client devices such as cellular phones, laptop computers, desktop computers, wearable devices, or tablet computers. The network 300 also may be connected to a larger network, such as the Internet, and may be configured to provide a client device with access to resources stored on or provided through the larger computer network.

### Example Methods

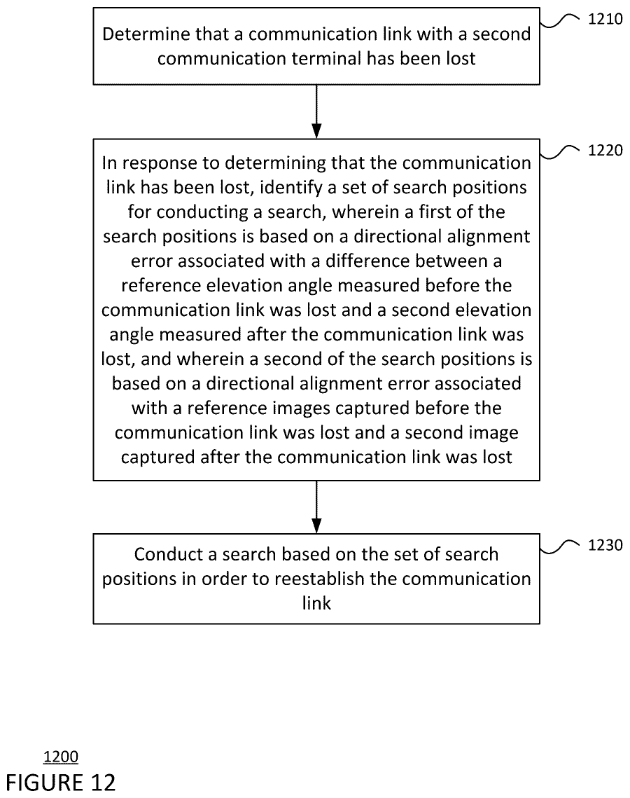

FIG. 12, is an example flow diagram 1200 in accordance with some of the aspects described above that may be performed by the one or more processors 104 of the first optical communications terminal 102. Additionally, or alternatively, the one or more processors 124 of the second optical communications terminal 122 may perform one or more steps of the flow diagram 1200. While FIG. 12 show blocks in a particular order, the order may be varied and that multiple operations may be performed simultaneously. Also, operations may be added or omitted.

Turning to FIG. 12, at block 1210, that a communication link with a second optical communication terminal has been lost is determined. As an example, a system may include a plurality of communication terminals, such as the first optical communication terminal 102 and second optical communication terminal 122. When the telescopes of these communication terminals are oriented towards one another at installation, a communication link may be established between the communication terminals via beams of light sent from one communication terminal to the other. The example of FIG. 4 depicts two communication terminals, including the first optical communication terminal 102 and the second optical communication terminal 122. In this example, the first optical communication terminal 102 is mounted on a building or other structure 410, and the second optical communication terminal 122 is mounted on a building or other structure 412. The telescopes 402, 422 of the communications terminals 102 and second optical communication terminal 122, respectively, are oriented towards one another and aligned. In this regard, the one or more processors 104 can send the beam of light 20a to the second optical communications terminal 122 through free space, and the one or more processors 124 can send communication signals using the beam of light 20b to the first optical communications terminal 102 through free space. These beams of light 20a, 20b are then received by each of the second optical communication terminal 122 and the first optical communication terminal 102, respectively. As a result, the communication link 22 is currently established between the two communication terminals.

Various calibration approaches may be used to enable the communication terminals to send and receive the aforementioned beams of light from one another. For instance, during initial installation, feedback may be provided to a human operator to enable adjustments to the communication terminals in order to adjust in both azimuth (AZ) and elevation (EL) to establish a communication link. This feedback can be visual, auditory or haptic, e.g. “go up”, “go a bit down”. Feedback can also be provided as an overlay onto a camera image indicating the target zone for correct alignment.

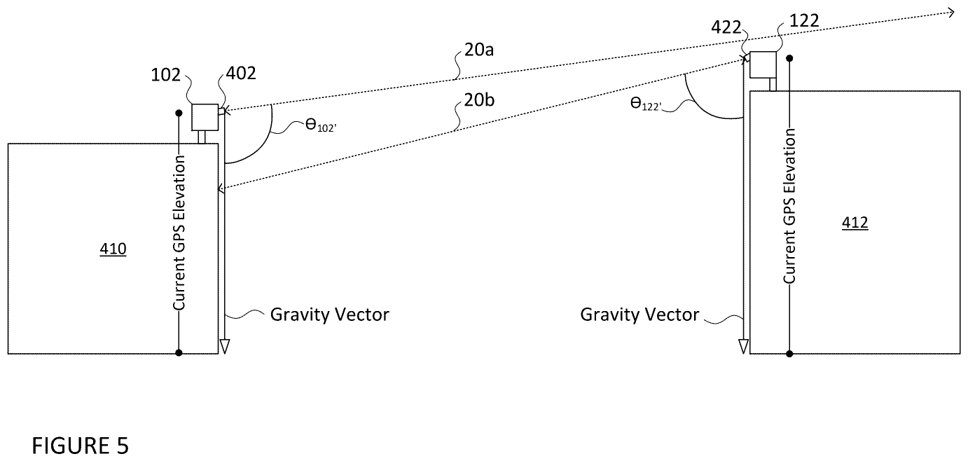

At some point in time, the communication terminals may come out of alignment. This may terminate all communications between the terminals. In other words, the communication terminals 102, 122 may no longer receive the beams of light from one another because the telescopes are no longer aligned. As shown in FIG. 5, the first optical communication terminal 102 and the second optical communication terminal 122 have come out of alignment. The telescopes 402, 422 of the communications terminals 102 and second optical communication terminal 122, respectively, are no longer oriented towards one another. In this regard, the one or more processors 104 can send the beam of light 20a, but it is not received by the second optical communications terminal 122. Similarly, the one or more processors 124 can send the beam of light 20b but it is not received by first optical communications terminal 102. As a result, the one or more processors 104 of the first optical communications terminal 102 and/or the one or more processors 124 of the second optical communications terminal 122 may determine that the communication link between the communications terminals have been lost.

In response, one or both of the communication terminals may identify one or more search positions. These search positions may be determined in any number of ways. In other words, the one or more processors 104 of the first optical communications terminal 102 and/or the one or more processors 124 of the second optical communications terminal 122 may determine a set of search positions. For instance, returning to FIG. 12, at block 1220, in response to determining that the communication link has been lost, a set of search positions for conducting a search are identified. As an example, a first of the search positions is based on a directional alignment error associated with a difference between a reference elevation angle measured before the communication link was lost and a second elevation angle measured after the communication link was lost. As another example, a second of the search positions is based on a directional alignment error associated with a reference image captured before the communication link was lost and a second image captured after the communication link was lost.

In some instances, a search position may be determined using a directional alignment error. In one example, location and elevation information from two different locations and differences in local tip and/or tilt data may be used to find a directional alignment error. In this regard, a current pointing vector for a communication terminal may be used to find a directional alignment error from the current pointing vector of the communication terminal.

For instance, the location coordinates of the first optical communication terminal 102 and second optical communication terminal 122 may be measured during installation, e.g., with GPS. The coordinates include longitude and latitude, as well as elevation above sea level. Using this information, a target angle and/or target “elevation vector” for a communication terminal may be determined and be stored locally at that communication terminal. The target angle may be determined relative to gravity (e.g., an axis normal to the earth's surface). A target elevation vector may define the three-dimensional location of the communication terminal and orientation of the telescope relative to gravity (e.g., more detailed than the target angle). The target angle and/or elevation vector may be determined as part of an installation process and stored in memory of the communications terminals. In addition, a real-time position of the telescope or target angle may also be calculated using data generated by on-board sensors. For instance, a target angle and/or target elevation vector may be determined by the processors of the communications terminals themselves using data from one or more sensors (such as the one or more sensors 220) as soon as a communication terminal is positioned (e.g., installed) and/or a communication link is established. As an example, target elevation angles θ102, 0122 for each of the first optical communication terminal 102 and the second optical communication terminal 122, respectively, as well as the GPS elevations are depicted in FIG. 4. Again, these may be used to determine a target angle and/or target elevation vector.

When communication is lost, a current elevation vector may be determined. As noted above, a current angle may be determined relative to gravity (e.g., an axis normal to the earth's surface). A directional alignment error may be determined based on the difference between the target angle and the current angle. Of course, this directional alignment error may also have some small error value attached to it (e.g., resulting from measurement errors of the sensor).

For instance, the current elevation vector may be determined using various sensors. For instance, the one or more sensors 220 of the first optical communications terminal 102 and/or the one or more processors 124 of the second optical communications terminal 122 may include a localized tilt sensor, e.g., an accelerometer of 2 or 3 axes, gyroscope, a pendulum with a weight, differential GPS, or other inertial measurement device (IMU). Such sensors may capture tilt measurements corresponding to movement of the communication terminal relative to the direction of earth's gravity and consequently, how much the communication terminal is pointing up or down. As a consequence, the tilt measurements can be used to calculate the current angle and/or current elevation vector (depending on the sensor data available) with respect to the gravity vector. For example, turning to the example of FIG. 5, the processors 104 of the first optical communication terminal 102 may determine the current GPS Elevation of the telescope 402 as well as the current elevation angle of the telescope θ_{102′} using data generated by one or more sensors 220 of the first optical communication terminal. Similarly, the processors 124 of the second optical communication terminal 122 may determine the current GPS Elevation of the telescope 422 as well as the current elevation angle of the telescope θ_{122′} using data generated by one or more sensors of the second optical communication terminal.

The processors of the communication terminals may then determine a directional alignment error using the differences in current pointing angle or direction and the target angle or elevation vector. For example, the processors 104 of the first optical communication terminal may determine a difference between the target elevation angle θ₁₀₂ and current pointing angle θ_{102′}. Similarly, the difference between the current elevation vector and the target elevation vector may be determined. One or both of these differences may then be used to mathematically calculate a directional alignment error. A similar approach may be used by the processors 124 of the second optical communication terminal 122 to determine a directional alignment error using the GPS elevations depicted in FIGS. 4 and 5 as well as the difference between the target elevation angles θ₁₂₂ and θ_{122′}.

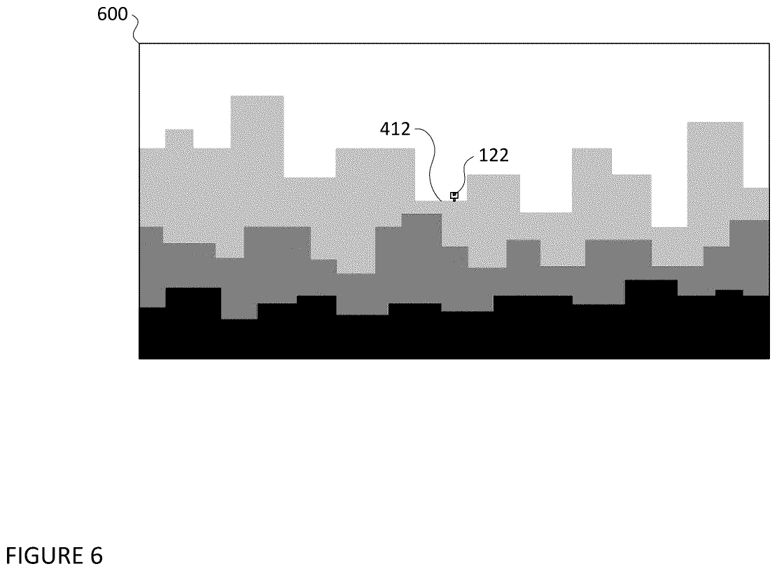

In addition or alternatively, a directional alignment error may be determined using image registration. For instance, after a link is established, a camera may be used by the processors of a communication terminal to capture an initial reference image of the remote environment. This “reference” image may then be stored locally at that communication terminal. For instance, the one or more processors 104 of the first optical communications terminal 102 may use a camera of the first optical communications terminal 102 to capture the reference image and may store the reference image in memory. FIG. 6 includes an example reference image 600 captured using a camera of the first optical communication terminal at a time when the first optical communication terminal is aligned with the second optical communication terminal 122 as in the example of FIG. 3. As can be seen, the reference image 600 includes a skyline (here a representation of a plurality of buildings at different depths) which includes both structure 412 as well as the second optical communication terminal 122. Similarly, the one or more processors 124 of the first optical communications terminal 122 may use a camera of the second optical communications terminal 122 to capture the reference image and may store the reference image in memory.

To increase the accuracy of the image registration, the camera of one communication terminal may be boresighted to the telescope of that communications terminal. For example, the camera of the first optical communication terminal 102 may be boresighted to the telescope of the first optical communication terminal 102 (or vice versa). In this regard, the center of the reference image 600 is aligned with the center of the pointing direction of the telescope. As a result, effects of changes to the reference image that are not related to changes in the pointing direction of either the beam of light or the angular orientation of the communication terminals should be reduced. Such changes may include influences such as lighting, weather, and temporary features, such as shadow movement, precipitation conditions (e.g., raindrops on the glass cover), cloud movement, airplanes, birds, waves, and so on. Because of such changing conditions, this reference image may be updated periodically or rather a new image may be captured and stored, for example, every 15 or 30 minutes.

The period of time after which each new image is captured may also be adjusted by the processors of the communication terminals as conditions change. For instance, at night in fair conditions, the frequency may be reduced as the lighting conditions may be fairly stable.

In other instances, when environmental conditions are windy, a communication terminal may be moving too much to capture a sufficient image for calculating the directional alignment error. Other sensors, such as the aforementioned accelerometer, gyroscope or IMU, may be used by the processors of that communication terminal to determine if the communication terminal is experiencing such windy conditions and therefore whether a new reference image should be captured and/or stored. For example, the processors 104 of the first optical communication terminal 102 may use data generated by the one or more sensors 220 to determine if the first optical communication terminal is moving to such a degree that a new reference image of the environment of the first communication should be captured and stored in memory of the first optical communication terminal. Similarly, the processors 124 of the second optical communication terminal 122 may use a sensor to determine if the second optical communication terminal is moving to such a degree that a new reference image of the environment of the second communication should be captured and stored in memory of the second optical communication terminal.

In some instances, the processors of a communication terminal may determine whether to store each new image. For example, using a similar method to image shift, or some other image subtraction method, a similarity score may be determined for the newly captured image and the stored image. If this similarity score does not meet a threshold, the new image may replace the stored image as the reference image. For example, the processors 104 of the first optical communication terminal 102 may capture a new image, determine a similarity score between the new image and the stored reference image, compare the score to a threshold, and replace the stored reference image in the memory of the first optical communication terminal with the new image. Similarly, the processors 124 of the second optical communication terminal 122 may capture a new image, determine a similarity score between the new image and the stored reference image, compare the score to a threshold, and replace the stored reference image in the memory of the second optical communication terminal with the new image.

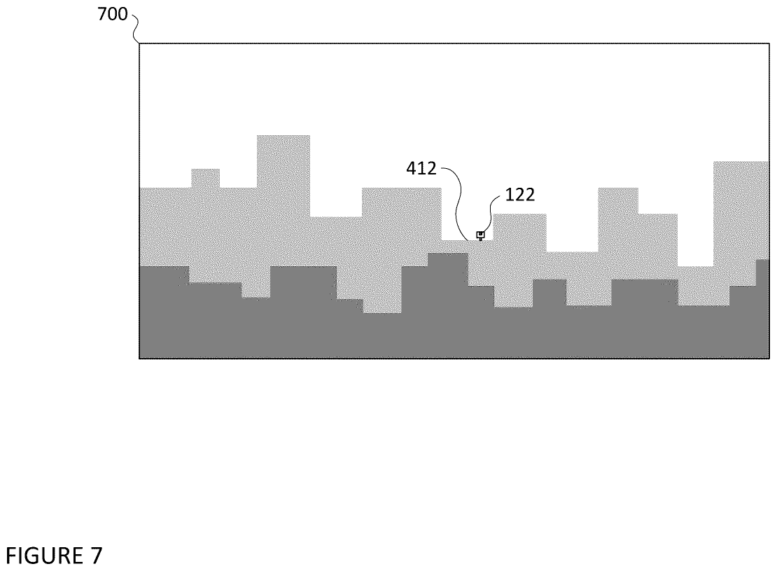

When the communication link is lost between two communication terminals, one or both of the communication terminals may capture a new image of the environment and compare that new image with the last stored reference image when the communication link was active. FIG. 7 includes an example new image 700 captured by the one or more processors of the first optical communication terminal using the camera of the first optical communication terminal at a time when the first optical communication terminal is no longer aligned with the second optical communication terminal 122 as in the example of FIG. 4. As can be seen, reference image 600 includes a skyline (here a representation of a plurality of buildings at different depths) which includes both structure 412 as well as the second optical communication terminal 122.

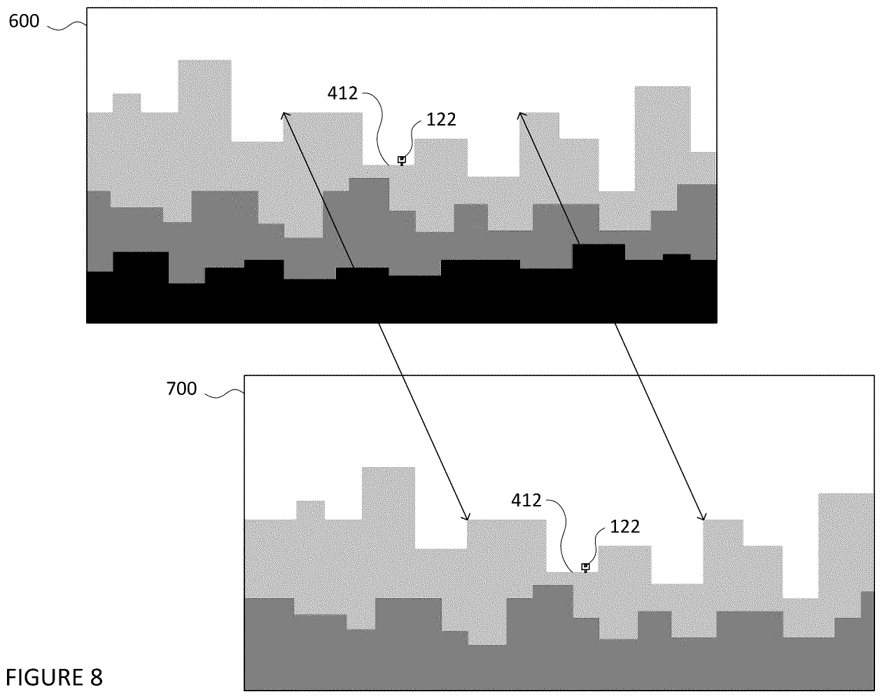

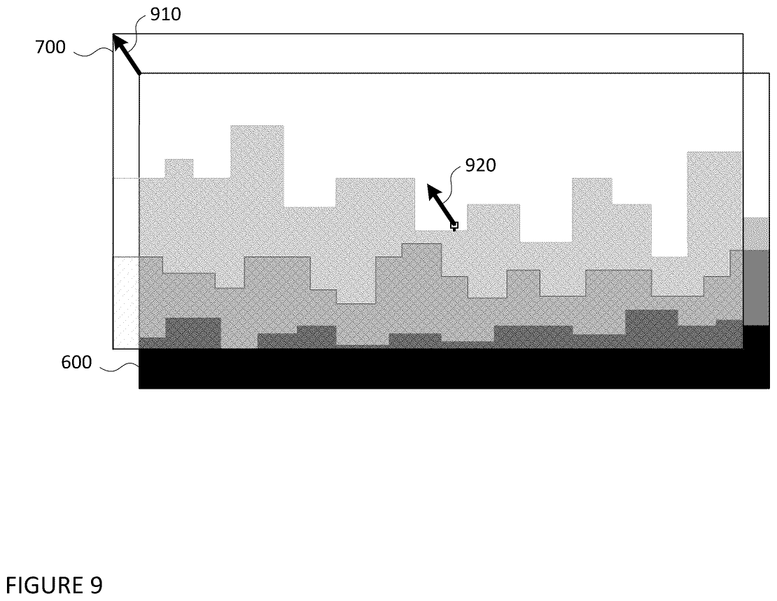

The processors of a communication terminal may then compare the images to determine an image offset vector. In one example, the processors of the communication terminal may use image registration to determine an image offset vector representative of a physical difference between features in the new image and the last stored reference image. This image offset vector may therefore be a directional alignment error (e.g., a vector with direction and magnitude). Of course, this directional alignment error may also have some small error value associated with it (e.g., resulting from the image registration process). For example, the processors 104 of the first optical communication terminal 102 may compare the reference image 600 to the new image 700. As depicted in FIG. 8, the processors 104 of the first optical communication terminal 102 may use image registration which involves identifying common features in the images, and use these features to determine an image offset vector between the reference image 600 to the new image 700. As shown in FIG. 9, which depicts new image 700 overlayed over reference image 600, an image offset vector 910, 920 may be determined. Image offset vector 920 represents the general direction and magnitude of the image offset. Similarly, the processors 124 of the second optical communication terminal 122 may use a similar approach to determine an image offset vector.

In some instances, to improve the image registration process, a reference point may be used. For example, each communication terminal may have a secondary light source which is constantly lit, flashes periodically or only as needed (for example, when a communication link is lost). This secondary light source may be a wide angle beam of light in order to increase the likelihood that the light source is captured by the image even when the communication terminals become mispointed. In addition, the light may be in the visual or infrared light spectrum depending upon the circumstances of the environment. In some instances, various filters (such as an IR filter in the case of a visible light camera) may be used in order to better identify the beam of light from the secondary light source. The location of the secondary light source may be used to align the images as part of the image registration process.

As an alternative to the image registration approach, an image offset vector may be determined using a machine learning model. For instance, the model may store the information about a plurality of reference images under different conditions and output an error vector based on a current image. As an example, this model may be structured as a deep learning model, such as a convolutional neural network. The model may be fully-trained on images from a given communications terminal, it may rely on a general model pre-trained on images from other terminals, or it may be a combination of both, using a general model that requires fine-tuning on local data. In addition or alternatively to outputting an image offset vector, the computer vision model may be used to assess the terminal's ability to reestablish a connection based on the current visibility. As an example, a model can use the camera image to infer rainy, snowy, or foggy conditions. In such a scenario, the model's output may be used to define the timing of when to start a search based on the current visibility.

In addition or alternatively, potential tracking positions may be periodically recorded. A tracking position may represent an angular orientation of a beam of light of a communications terminal during any point in time when the terminal is able to receive power from a beam of light emitted from another communications terminal. A tracking position may be calculated using any combination of the angular position of the steering mirror, orientation of the terminal, orientation of the telescope, and/or incidence angle of the beam measured via the OPA architecture 114. For instance, during tracking, a steering mirror may be adjusted in order to adjust the position of the telescope of a communications terminal and thereby reorient the beam of light in real time in order to make adjustments due to small environmental changes that may affect the power of the beam of light received at the other communication terminal. As an example, heat from the sun and other such environmental conditions can result in movement of the structure that the communication terminal is mounted on and may be compensated for with minor adjustments to the angular orientation of the steering mirror. Each time the steering mirror is adjusted, the new position of the steering mirror (e.g., new tracking position) may be stored as historical alignment data. Again, this new position (and corresponding historical alignment data) will have some associated error value. In addition or alternatively, tracking positions at different times of day for different days, weeks, months, seasons, etc., may be stored as historical alignment data for later retrieval as search positions for corresponding times of day, etc. In some instances, the current inertial angle (e.g., measured from a sensor as described above) may be stored with the tracking position of the steering mirror to increase the accuracy of the historical alignment data.

Returning to FIG. 12, at block 1230, a search is conducted based on the set of search positions in order to reestablish the communication link. For instance, the processors of the communication terminal may determine (or select) a search position that would reorient the beam of light (e.g., by controlling an actuator of the steering mirror and/or controlling the orientation and/or position of the telescope), and initiate a search to correct for the misalignment automatically. As noted above, the communication terminal may conduct a search by “stepping” through its field of regard in a thorough pre-defined pattern starting from the corrected position, with the goal of locating a beam of light being transmitted from another communication terminal.

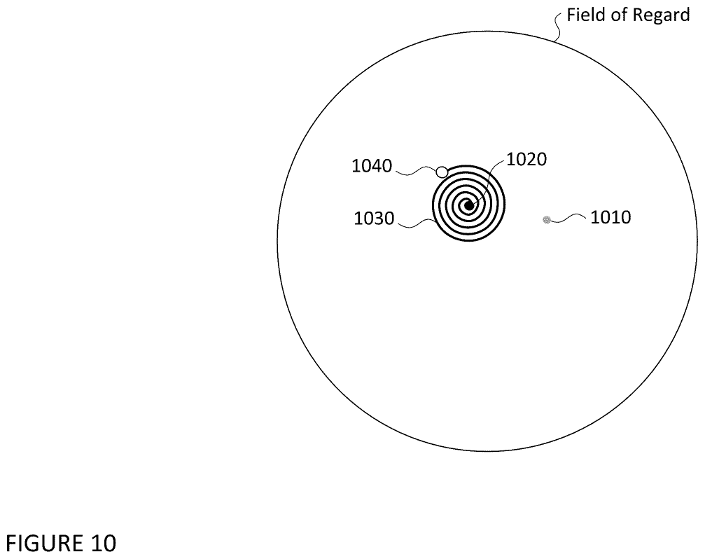

For example, the processors 104 of the optical communications terminal 102 may determine a search position by selecting one of the one or more directional alignment errors and/or historical alignment data. This search position may correspond to an adjustment to the telescope of communication terminal 102 and/or an adjustment to steering mirror 222 of the optical communications terminal 102 in order to reorient the beam of light towards the telescope of the second optical communication terminal 122 in order to compensate for the one or more directional alignment errors or at a position of the historical alignment data. As depicted in FIG. 10, the one or more processors 104 of the optical communications terminal 102 may adjust the current pointing direction 1010 of the optical communications terminal 102 to an initial search position 1020.

These adjustments may be performed via any known mechanical means, such as adjusting a position of the steering mirror for smaller errors and/or adjusting a motorized mount such as a gimbal via a small motor or solenoid for larger errors. The adjustments may be autonomous or manually executed by a human operator (either remotely through teleoperation or via a physical interaction with the communications terminal). If the magnitude of the required correction exceeds the physical capabilities of the system, the system may send an alert to a human operator about the necessity of a manual intervention or an expected longer outage. These adjustments may correct for at least one of a directional alignment error or may reposition the steering mirror of the communication terminal according to the historical alignment data. However, even after this reorientation of the outgoing beam of light from the first optical communication terminal, it is likely that there will still be some alignment errors for instance, due to errors in the directional alignment errors, search positions, historical alignment data, and/or steering errors. In this regard, after the reorientation, a search may be initiated by the processors 104 of the first optical communication terminal 102 in order to reestablish a communication link with the second optical communication terminal. A similar approach may be used by the processors 124 of the second optical communication terminal 122.

Returning to FIG. 10, the first optical communication terminal 102 may have come out of alignment with the second optical communication terminal 122 and is currently pointed at current pointing direction 1010. The processors 104 of the first optical communication terminal may adjust the pointing direction of the communication terminal 104 to an initial search position 1020, for example, by adjusting the position of the telescope of the first optical communication terminal and/or the steering mirror. This initial search position may correspond, for example, to an adjustment for any of the aforementioned directional alignment errors and/or to a pointing direction of the historical alignment data. After any adjustments, the first optical communication terminal may conduct a spiral-based search by adjusting the pointing direction of the first optical communication terminal to follow the search trajectory 1030. Thus, in this example, search trajectory 1030 starts at the initial search position 1020 and continues until the first optical communication terminal 102 is realigned with the second optical communication terminal 122 at position 1040. At this point, a communication link is established (or reestablished). Although a spiral-based pattern is depicted, other search patterns may also be used.

If the search starting at the initial search position does not result in a connection between the two terminals, the communication terminal may determine another search position, for example, by selecting another one of the one or more directional alignment errors and/or historical alignment data, reorienting the beam of light to that search position, and conducting another search and so on until the communication link is established. A similar approach may be used by the processors 124 of the second optical communication terminal 122.

The selection of the directional alignment errors and/or historical alignment data for the initial search position may be based on a predefined list. As an example, the list may begin with the smallest change in pointing direction and working towards the greatest change in pointing direction or vice versa. Alternatively, the list may start with the search position with the least amount of expected error and work towards the search position with the greatest amount of expected error or vice versa. For instance, in many cases the image registration approach may have a relatively small associated error value from calculating the difference between the target pointing angle and the current pointing angle, whereas an IMU may have a greater associated error value from the measurement of the elevation angle. Thus, a search position based on the directional alignment error from the image registration may be used for a search before a search position based on the directional alignment error from an IMU or vice versa.

Alternatively, the communication terminal may determine a set of two or more search positions from the one or more directional alignment errors and/or historical alignment data. The communication terminal may then combine these values to determine a location, for example, by taking an average of two or more search positions, determining a centroid, or using another metric to combine the values, and use this location as an initial search position. The communication terminal may then reorient the beam of light to that initial search position as discussed above to compensate for the directional alignment error. The search may continue until a communications link is established between the communication terminals.

As another alternative, the communication terminal may conduct a distributed search using a plurality of search locations based on a combination of any of the current location of the telescope and steering mirror (e.g., current pointing direction), directional alignment errors and/or historical alignment data. As an example, the processors 104 of the first optical communication terminal 102 may use various formulations such as an ergodic metric, KL-divergence or other numerical quantity that compares two distributions to mathematically formulate a cost function to generate a trajectory that will be optimal with respect to the underlying distribution of the current pointing direction, any search positions and any associated error values. A search trajectory generated in this way may enable a search of the FOR that prioritizes exploring angles with a high likelihood of successful alignment. This probability-based approach should therefore guide the search using the distributions of the error values and result in faster and more reliable reacquisition than either a blind search of the full field of regard or any type of raster-based search. A similar approach may be used by the processors 124 of the second optical communication terminal 122.

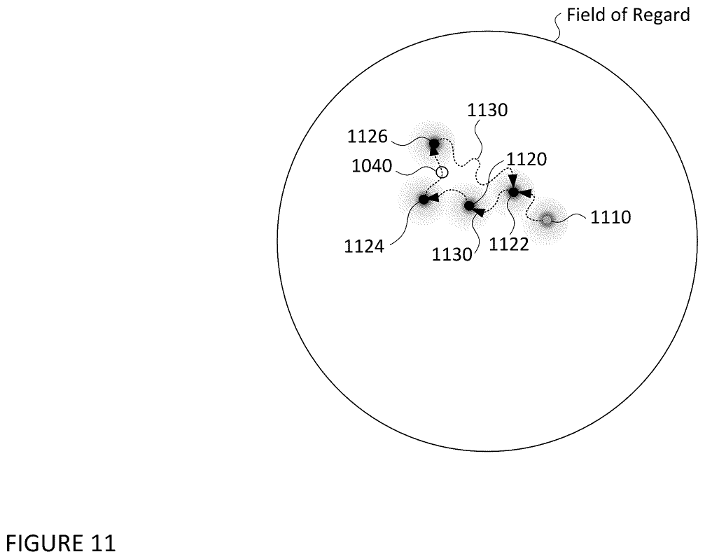

FIG. 11 depicts a distribution-based search pattern following search trajectory 1030. In this example, search trajectory 1130 may represent a trajectory determined as described above based on a plurality of search positions 1120, 1122, 1124, 1126, including the current pointing direction 1110 of the first optical communication terminal. In this regard, each of the search positions 1120, 1122, 1124, 1126 may correspond to an adjustment to compensate for any of the aforementioned directional alignment errors or historical alignment data. In this example, each of the current pointing direction and the plurality of search positions is depicted with a shaded area representing a probability distribution that represents the confidence and expected error range associated with that pointing direction or position. This information may then be used to create the underlying distribution for the trajectory-generation approach as discussed above. In this example, rather than starting at an initial search position, the search trajectory begins at the current pointing direction 1110 (also current pointing direction 1010 of FIG. 10) of the first optical communication terminal, and will continue along the search trajectory 1130 until the first optical communication terminal 102 is realigned with the second optical communication terminal 122 at position 1040. At this point, a communication link is established (or reestablished).

In another example, the one or more directional alignment errors and/or historical alignment data may be sent to a remote computing device (e.g., via cellular or WiFi connection) and provided to a human operator to enable the human operator to physically reposition the communication terminal. For example, the human operator may orient the aperture of the communication terminal to compensate for one or more directional alignment errors and initiate a search. If a search does not result in a connection between the two terminals, the human operator may orient the aperture of the communication terminal towards another using the one or more directional alignment errors. This may continue until the search is successful and a communications link is established between the communication terminals.

In some instances, a directional alignment error may exceed the field of regard of the communication terminal. For example, a steering mirror or gimbal may not be able to be moved or otherwise adjusted far enough to correct for the directional alignment error. In such situations, a signal may be sent by the processors of the communication terminal to a remote computing device (e.g., via cellular or WiFi connection) and provided to a human operator to enable the human operator to physically correct the alignment (e.g., by manipulating the communication terminal in person or remotely by some other means, such as a remotely-controlled gimbal).

In addition to being used for determining directional alignment errors, the captured images may be used to determine other types of information. For instance, these images may be processed to determine the time, frequency and magnitude of disturbance events and to determine whether the disturbance event is regular and/or periodic. In such instances, future disturbance events could potentially be anticipated and compensated for before they occur. As an example, the images as well as timestamps identifying when the images were captured could be used as a trainable data set for prediction of disturbance events and resulting impact to directional alignment errors.

In some instances captured images may also be used to provide additional information above and beyond alignment errors. For example, in the event of heavy haze, fog or rain, communication may not be possible even after correcting misalignment. This information about real-time visibility can be used to optimize a search pattern, to give a human operator insight into expected availability or downtime of the link, and/or to trigger human intervention. For example, when visibility is minimal, it may be preferable for the terminal to delay any adjustments and/or searching until conditions improve. As another example, in the event an object is physically blocking line of sight between terminals, communication may not be possible even after correcting misalignment. In such instances, a signal may be sent by the processors of the communication terminal to a remote computing device (e.g., via cellular or WiFi connection) and provided to a human operator to enable the human operator to physically correct the alignment (e.g., by manipulating the communication terminal in person or remotely by some other means, such as a remotely-controlled gimbal).

The features described herein provides for real-time alignment correction and searching to reestablish lost communications links in terrestrial free space optical communications (FSOC) systems. This alignment correction and search process may increase efficiency of searches, significantly reducing the time needed to establish and reestablish a connection between communication terminals after a communications link is lost. These improvements to the acquisition and reacquisition processes may therefore significantly reduce downtime for the system. In addition, the features described herein may also improve transparency of system operations to human operators, enabling the human operators to intervene promptly when issues are not possible to be fixed autonomously.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising a first optical communication terminal having one or more processors configured to:
determine that a communication link with a second optical communication terminal has been lost;
in response to determining that the communication link has been lost, identify a set of search positions for conducting a search, wherein a first of the search positions is based on a directional alignment error associated with a difference between a reference elevation angle measured before the communication link was lost and a second elevation angle measured after the communication link was lost, and wherein a second of the search positions is based on a directional alignment error associated with a reference image captured before the communication link was lost and a second image captured after the communication link was lost; and
conduct a search based on the set of search positions in order to reestablish the communication link.

2. The system of claim 1, wherein the first optical communication terminal further includes a sensor, and the one or more processors are further configured to use the sensor to measure the reference elevation angle and the second elevation angle.

3. The system of claim 2, wherein the sensor includes one of an inertial measurement unit, a gyroscope, or an accelerometer.

4. The system of claim 1, wherein the first optical communication terminal further includes a camera, and the one or more processors are further configured to capture the reference image and the second image.

5. The system of claim 1, wherein the one or more processors are further configured to select the reference image based on when the second image was captured.

6. The system of claim 1, wherein the one or more processors are further configured to determine the directional alignment error associated with the reference image using image registration between the reference image and the second image.

7. The system of claim 1, wherein the one or more processors are further configured to use a light source of the second optical communication terminal in each of the reference image and the second image to determine the directional alignment error associated with the reference image.

8. The system of claim 1, wherein the set of search positions further includes a historical position of a steering mirror of the first optical communication terminal.

9. The system of claim 1, wherein the one or more processors are further configured to conduct the search by:
determining an average of the search positions of the set; and
adjusting the first optical communication terminal based on the average before initiating the search.

10. The system of claim 1, wherein the one or more processors are further configured to conduct the search by:
selecting one of the set of search positions; and
adjusting the first optical communication terminal based on the selected one before initiating the search.

11. The system of claim 10, wherein selecting the selected one is based on error values associated with each of the directional alignment errors.

12. The system of claim 1, wherein the one or more processors are further configured to conduct the search by determining a trajectory for the search using a probability distribution for the set of search positions, and wherein the search is conducted based on the trajectory.

13. The system of claim 12, wherein the one or more processors are further configured to determine the trajectory using an ergodic approach.

14. A method comprising:
determining, by one or more processors of a first optical communication terminal, that a communication link with a second optical communication terminal has been lost;
in response to determining that the communication link has been lost, identifying, by the one or more processors, a set of search positions for conducting a search, wherein a first of the search positions is based on a directional alignment error associated with a difference between a reference elevation angle measured before the communication link was lost and a second elevation angle measured after the communication link was lost, and wherein a second of the search positions is based on a directional alignment error associated with a reference image captured before the communication link was lost and a second image captured after the communication link was lost; and
conducting, by the one or more processors, a search based on the set of search positions in order to reestablish the communication link.

15. The method of claim 14, using a sensor of the first optical communication terminal to measure the reference elevation angle and the second elevation angle.

16. The method of claim 14, determining the directional alignment error associated with the reference image using image registration between the reference image and the second image.

17. The method of claim 14, using a light source of the second optical communication terminal captured in each of the reference image and the second image to determine the directional alignment error associated with the reference image.

18. The method of claim 14, wherein conducting the search includes:
determining an average of the search positions of the set; and
adjusting the first optical communication terminal based on the average before initiating the search.

19. The method of claim 14, wherein conducting the search includes determining a trajectory for the search using a probability distribution for the set of search positions, and wherein the search is conducted based on the trajectory.

20. The method of claim 19, wherein determining the trajectory includes using an ergodic approach.
